(19) United States
(12) Patent Application Publication
(10) Pub. No.: US 2017/0339968 A1
(43) Pub. Date: Nov. 30, 2017

(54) SYSTEM, APPARATUSES AND METHODS FOR CONTROLLING THE RIPENING OF PERISHABLE FOODS

(71) Applicants: Alan EDELMAN, Hatfield, PA (US); Barry Joel EDELMAN, Matthews, NC (US)

(72) Inventors: Alan EDELMAN, Hatfield, PA (US); Barry Joel EDELMAN, Matthews, NC (US)

(21) Appl. No.: 15/163,095

(22) Filed: May 24, 2016

(51) Int. Cl. A23B 7/152; A23B 7/158

(52) U.S. Cl. CPC A23B 7/152; A23B 7/158; A23V 2002/00

(57) ABSTRACT

A system for controlling the ripening of perishable foods is provided.

### BACKGROUND OF THE INVENTION

The present invention relates to food management and, more particularly, to a system for controlling the ripening of perishable foods. Every year tons of post harvested fruits and vegetables are thrown away due to natural or microbial spoilage. Perishable food items, like fruits and vegetables, are living organisms, and like other living organisms, they undergo natural biological aging processes. A major contributor to this natural aging process involves the “pathways” leading to ethylene metabolism, wherein ethylene helps to ripen food and also ushers in senescence, resulting in spoilage. Microbe, Mold, and fungus assaults account for the majority of early food degenerative spoilage.

The agricultural industry maximizes profits by delivering small portions of a farm's overall yield to separate, possibly hundreds of, markets before spoilage. As a result, the industry favors harvesting almost ripe items that complete their ripening en route to these marketplaces and/or between the marketplaces and the end consumers.

, which initiates a race to get the ripened food to the consumer before spoilage. The end result being excessive amount of spoilage, engorging the landfills, and creating excess amounts of methane a ‘greenhouse gas’. The consumer has a very short time to consume the food before spoilage.

This apparatus will enable farmers to harvest a little earlier than normal since the device can maintain or encourage the ripening process. Insects favor vine ripening food rather than immature “green” items, and so harvesting food items when they are unripe reduces losses from insects, increasing crop yield and reducing the use of pesticides. As can be seen, there is a need for a system for controlling the ripening of perishable foods, involving delaying, inhibiting, suspending, or encouraging the internal biological aging processes, as well as, eliminating structural degeneration due to microbial corruption.

### SUMMARY OF THE INVENTION

In one aspect of the present invention, apparatus, a preserving apparatus includes a first compartment defined by a plurality of sidewalls and a first moveable wall, wherein the first moveable wall pivots between an open condition and a closed condition, hermetically sealing the first compartment; a portal opening defined by the first movable wall; an active glove sealed along the portal opening; an input/output tray provided by one of the plurality of sidewalls, wherein the input/output tray slides between an extended condition and a contracted condition, hermetically sealing the first compartment; and a food management gas fluidly connected to the first compartment.

In another aspect of the present invention, apparatus, the preserving apparatus includes a first compartment defined by a plurality of sidewalls and a transparent first moveable wall, wherein the first moveable wall pivots between an open condition and a closed condition, hermetically sealing the first compartment; a portal opening defined by the first movable wall; an active glove sealed along the portal opening; an input/output tray provided by one of the plurality of sidewalls, wherein the input/output tray slides between an extended condition and a contracted condition, hermetically sealing the first compartment; a food management gas fluidly connected to the first compartment and the input/output tray, wherein the food management gas includes argon, carbon dioxide, and oxygen at ratio of approximately 80 parts per 100, 18 parts per 100, and 2 parts per 100, respectively; and a dipping tray disposed along a lower portion of the first compartment, wherein the dipping tray provides a dipping solution, wherein the dipping solution inhibits at least one ethylene process.

These and other features, aspects and advantages of the present invention will become better understood with reference to the following drawings, description and claims.

### BRIEF DESCRIPTION OF THE DRAWINGS

FIG. 1 is a bottom perspective view of an exemplary embodiment of the present invention, without a first moveable wall for illustrative clarity;

FIG. 2 is a top perspective view of an exemplary embodiment of the present invention, without the first moveable wall for illustrative clarity;

FIG. 3 is a perspective view of an exemplary embodiment of the present invention, with the first moveable wall and with an input/output tray in an extended condition;

FIG. 4 is a perspective view of an exemplary embodiment of the present invention, with the first moveable wall and with the input/output tray in a contracted condition with its tray lid in an open condition;

FIG. 5 is a perspective view of an exemplary embodiment of the present invention, with the first moveable wall in an open condition;

FIG. 6 is a bottom perspective view of an exemplary embodiment of the present invention, without the first moveable wall for illustrative clarity;

FIG. 7 is a top perspective view of an exemplary embodiment of the present invention, without the first moveable wall for illustrative clarity;

FIG. 8 is a schematic view of an exemplary embodiment of the present invention;

FIG. 9 is a schematic view of an exemplary embodiment of the present invention;

FIG. 10 is a section detail view of an exemplary embodiment of the present invention, shown along line 10-10 in FIG. 4;

FIG. 11 is a section view of an exemplary embodiment of the present invention;

FIG. 12 is a section view of an exemplary embodiment of the present invention;

FIG. 13 is a perspective view of an exemplary embodiment of the present invention;

FIG. 14 is a perspective view of an exemplary embodiment of the present invention;

FIG. 15 is a perspective view of an exemplary embodiment of the present invention;

FIG. 16 is a perspective view of an exemplary embodiment of the present invention;

FIG. 17 is a front top right perspective view of an exemplary embodiment of the present invention;

FIG. 18 is a front top left perspective view of an exemplary embodiment of the present invention;

FIG. 19 is a front bottom right perspective view of an exemplary embodiment of the present invention;

FIG. 20 is a front bottom left detail perspective view of an exemplary embodiment of the present invention;

FIG. 21 is a schematic view of an exemplary embodiment of the present invention; and

FIG. 22 is a rear perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a food management system for controlling the ripening of perishable foods, involving delaying, suspending, or encouraging the internal biological aging processes, as well as, eliminating degeneration due to microbial corruption. The food management system includes apparatuses embodying methods for maintaining an absolute sterile, germicidal, environment that will completely eliminate surface and subsurface microbial activity, keeping food items free of microbe assaults while they remain in the apparatuses and until they can be consumed. The methods employ various resources in an attempt to directly manipulate, postpone, and inhibit ethylene metabolism and other enzymatic and biochemical activity. These methods and portable apparatuses will directly, and indirectly, effect the processing of post harvested food items. The device can maintain the unripe stage of “immature” harvested food items, and then hasten their ripening stage when desired. The method described here can be applied by using either one two, or three devices. For example, there can be one stand alone, battery operated, apparatus containing two or three separate compartments, one for preserving, one for ripening and one for freezing. An alternative is to have three completely separate, stand alone, battery operated apparatuses each performing one specific task. Three completely separate stand-alone devices are described and illustrated herein to better clarify all aspects of the outlined method. Furthermore, the described methods and associated apparatuses can provide a consumer oriented home appliance, or provide a commercial oriented system that attempts to maintain food items in a ripe or unripe stage by controlling their ripening and spoilage. The immature stage will be preserved for a longer period of time then is currently possible, whereby the ripened food can also be placed in a preserving apparatus to maintain the ripened stage for an extended period.

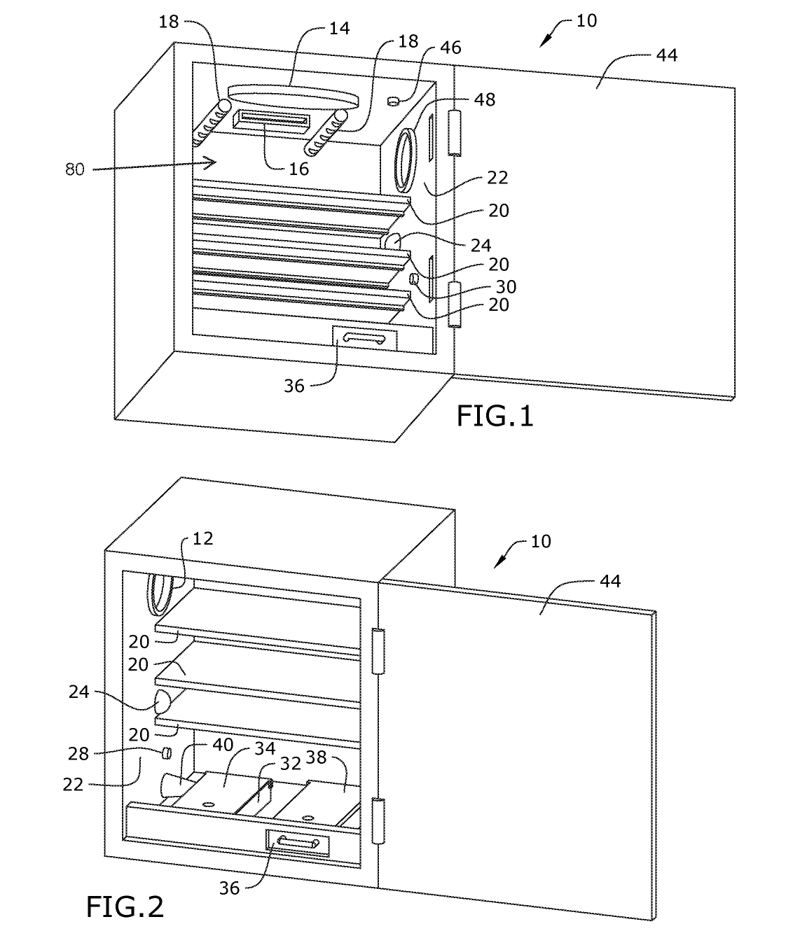

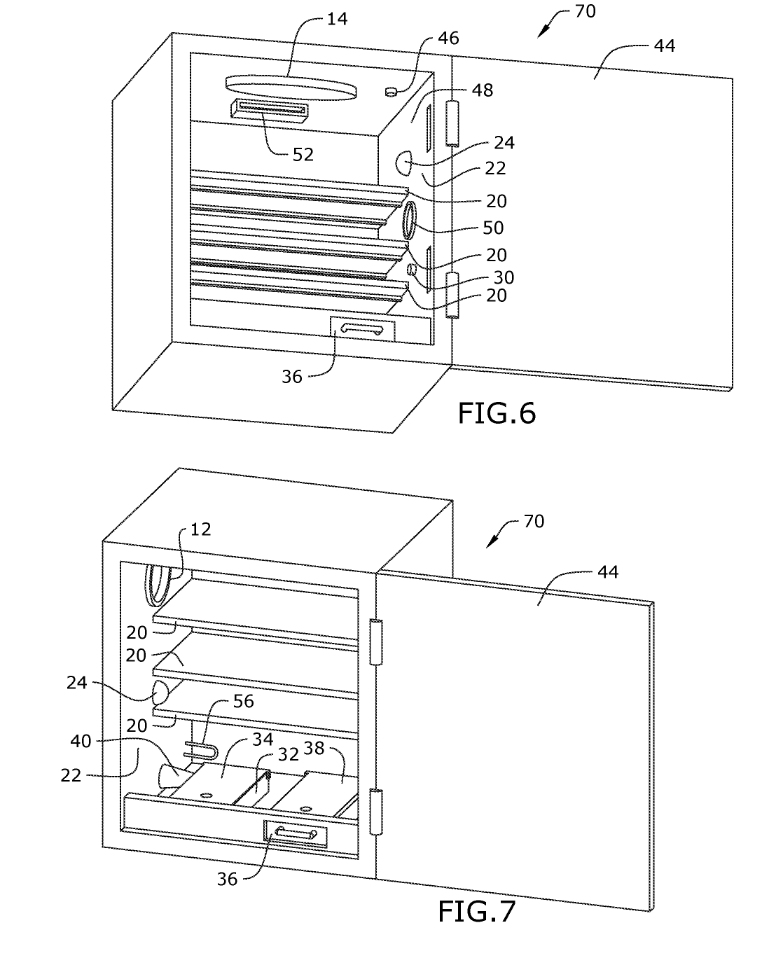

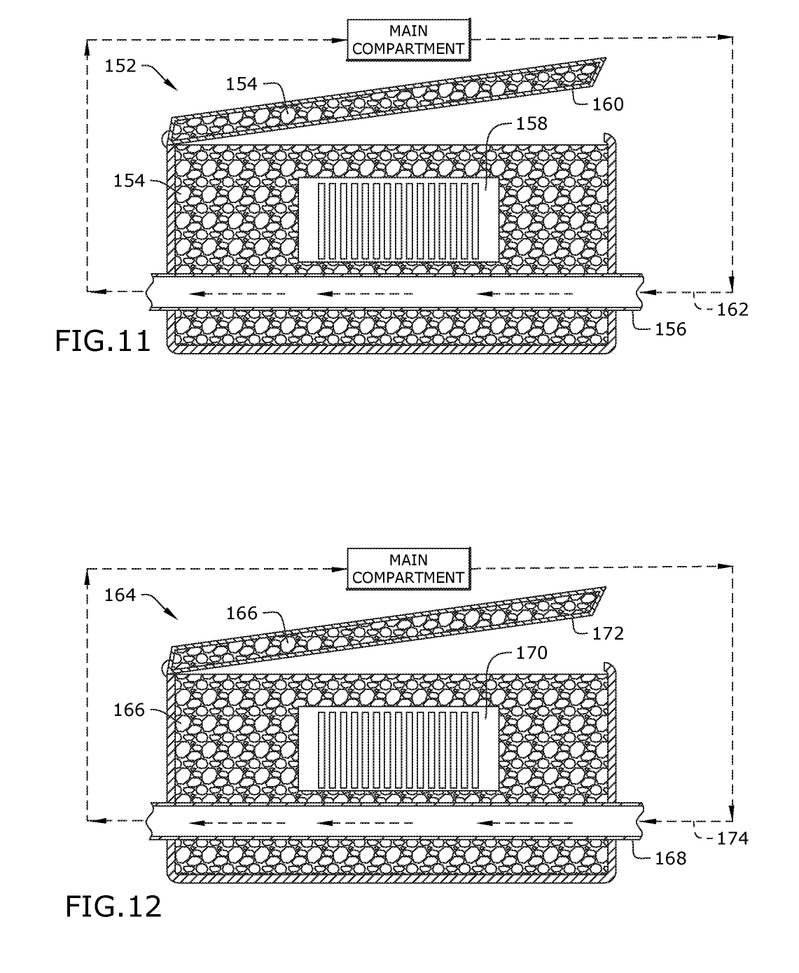

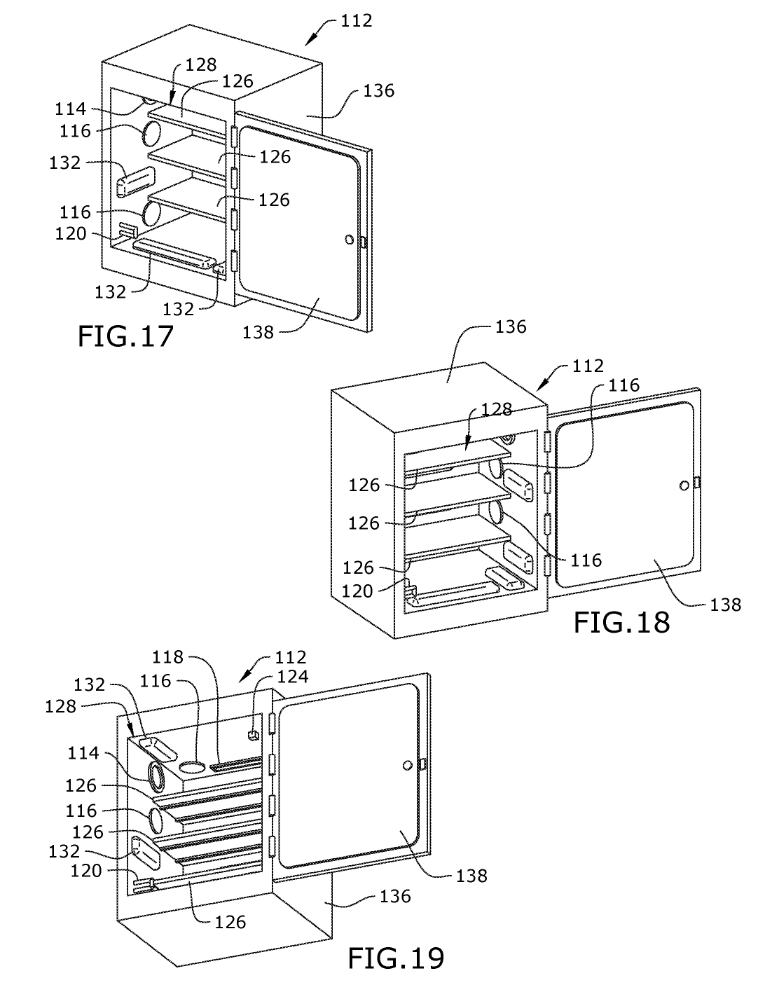

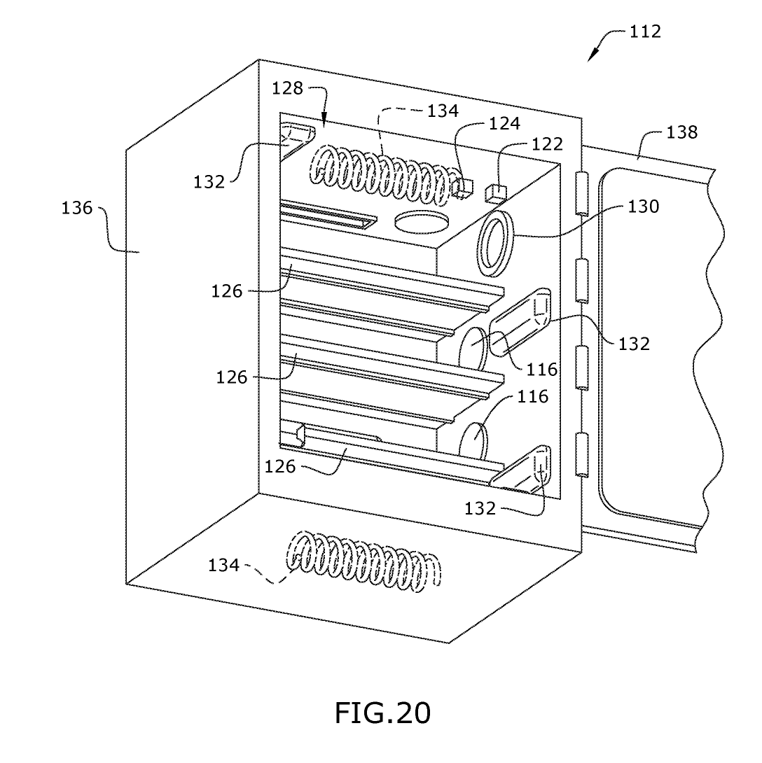

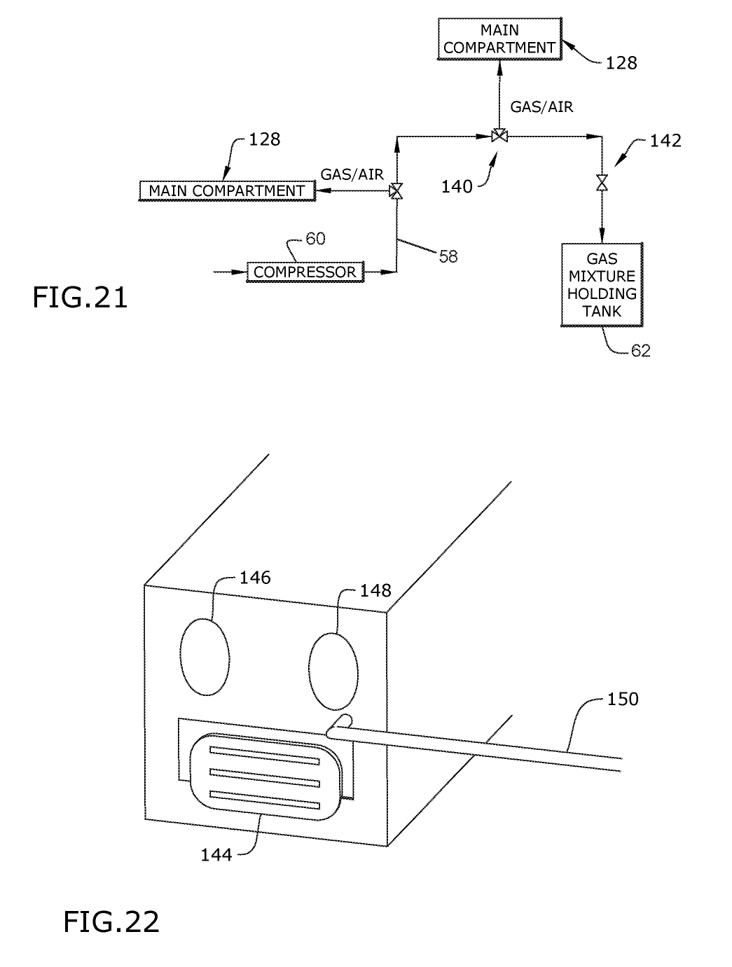

Referring to FIGS. 1 through 22, the present invention may include a food management apparatus 10, 70, 112. The food management apparatus 10 may include a plurality of sidewalls 22, 136 defining a first compartment 80, 128. the food management apparatus 10 may define a second compartment 152, while in other embodiments, the second compartment , 164 may be part of a standalone freezing apparatus. The plurality of sidewalls 22, 136 may provide a reflective surface, such as mirrored, to reflect a UV emissions being generated from internal UV sources.

A plurality of adjustable grated shelves 20, 126 may span at least a portion of the first compartment 80, 128, wherein each grated shelf 20, 126 is dimensioned and adapted to support a plurality of perishable food items, like fruits and vegetables (not shown). The plurality of adjustable grated shelves 20, 126 and the plurality of sidewalls 22, 136 may provide nanoparticles, for example silver, and titanium dioxide, to enhance the germicidal effect on microbes that might be present in the first compartment 80, 128.

A first movable wall 42 may be pivotally attached the food management apparatus 10 so as to move between an open condition and a closed condition, wherein an airtight seal is formed between at plurality of the sidewalls and the first movable wall 42 in the closed condition so that the first compartment 80, 128 is hermetically sealed. The first moveable wall 42 may be made from a transparent material, like glass.

A second movable wall 44, 138 may be pivotally attached the food management apparatus 10 so as to move between an open condition and a closed condition, covering the first moveable wall 42 in the closed condition. While in the open condition the first movable wall 42 is visible and so is the content of the first compartment 80, without exposing it to contaminated room air. The second moveable wall 44, 138 may not be made from an opaque material.

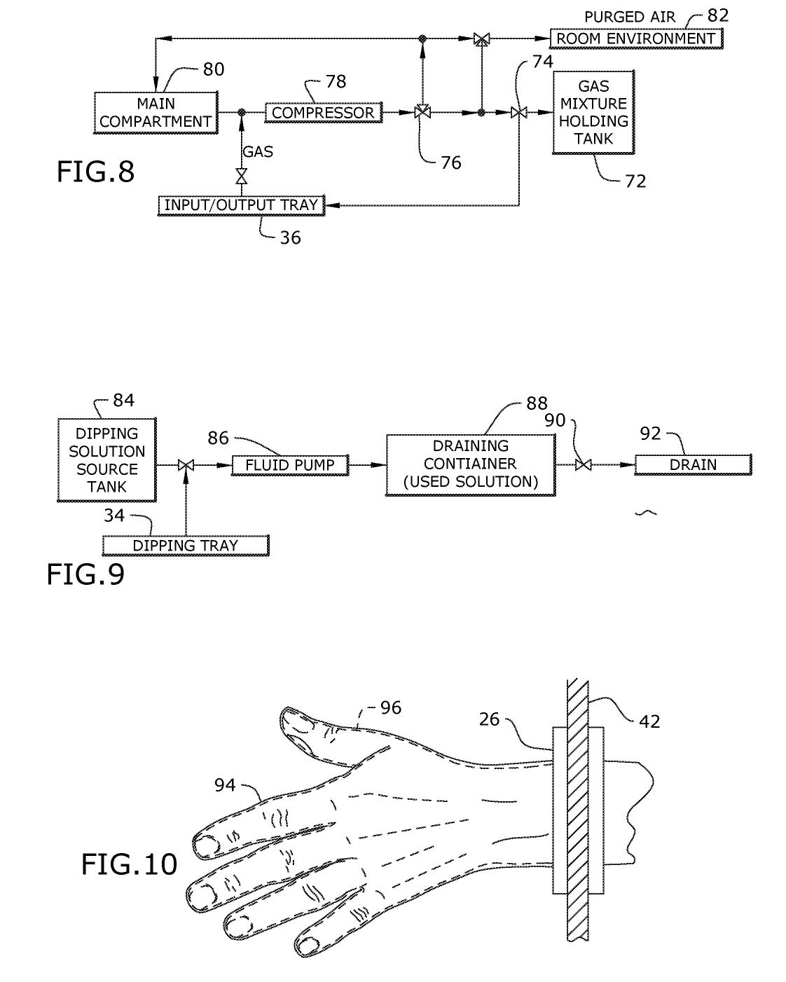

The atmosphere—i.e., the mixture and concentrations of gases—in the first compartment 80, 128 may be controlled through the introduction or removal of a plurality of food management gases via at least one gas intake/exhaust ports 16, 118, 52 operatively disposed in the first compartment 80, 128. The food management preserving gases may include argon, carbon dioxide, and oxygen or any other beneficial combination. In certain embodiments, the ratios may be 80%, 18%, 2% respectively. The ripening gas will not contain carbon dioxide and instead provide ethylene and any other ripening combination. The food management gas may be stored in a removable holding tank 72. The removable holding tank 72 may be disposed near the rear of the food management apparatus 10. The removable holding tank 72 is used both as a gas “source” and as a gas “holding tank” by way of a compressor 78 adapted to urge the food management gas to and from the first compartment 80, 128 and the removable holding tank 72. The compressor 78 may also be adapted to purge any room air from the first compartment 80, 128, room air, for example, being surrounding air/gases 82 that entered the first compartment 80, 128 through exposed when, say, the first moveable door 42 was in the open condition. The compressor 78 may be fluidly connected to the first compartment 80, 128, the surrounding air/gases 82, the removable holding tank 72 by way of release and shutoff valves 74, 76, 140, 142, as illustrated in FIG. 8.

The first movable wall 42 may provide at least one active portal opening 26, each active portal opening 26 defined by an airtight peripheral seal along the first movable wall 42. An active glove 94 may be attached along the airtight peripheral seal of each active portal opening 26, wherein each active glove 94 made of gas or fluid impermeable material, such as rubber, and dimensioned so that an operator may slide their hand 96 through the associated active portal opening 26 and into the active glove 94, maintaining the hermetical seal about the first compartment 80, 128 when the first movable wall 42 is in the closed condition, as illustrated in FIG. 10. Each active glove 94 enables the operator to manipulate the contents of the first compartment 80, with the first moveable door 42 in the closed condition, wherein two active gloves 94 can be utilized simultaneously to facilitate ambidextrous manipulation of said contents, while maintaining the sealed, sterile environment.

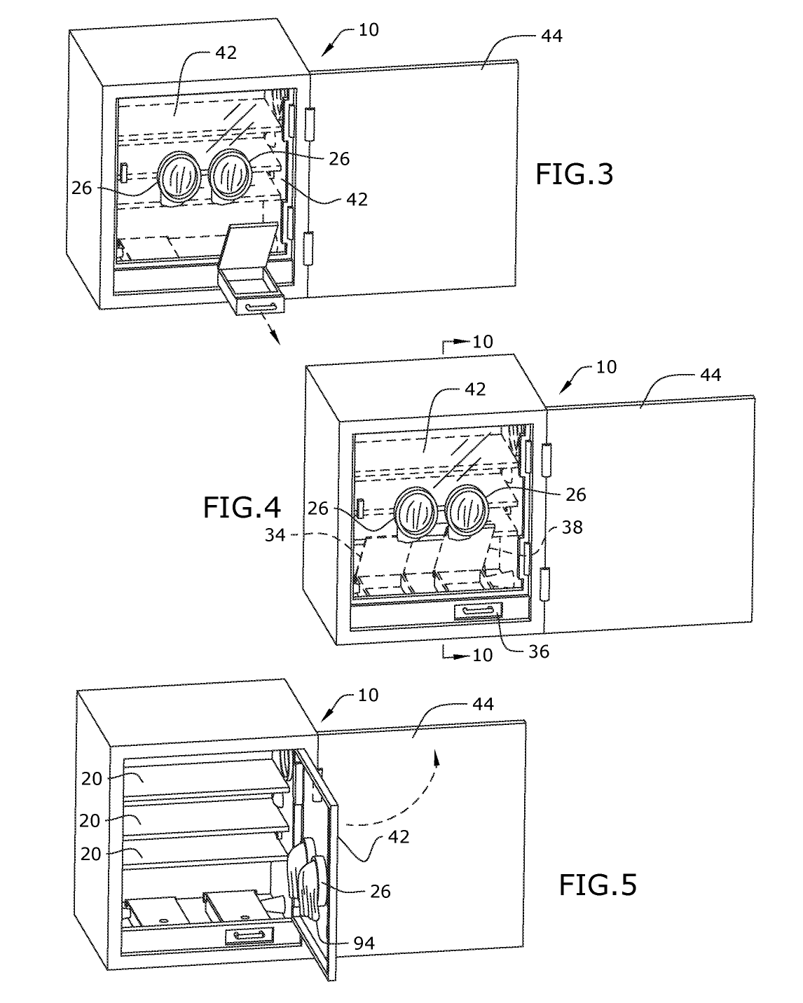

One of the plurality of sidewalls 22, or a portion thereof, may provide at least one input/output tray 36 that is moveable between an extended and contracted condition inside, hermetically sealed in the first compartment 80. In the extended condition, the input/output tray 36 is disposed outside the first compartment 80, beyond the plurality of sidewalls 22, so that it may be accessed, as illustrated in FIG. 3. Accessibility to a tray compartment defined by the input/output tray 36 may be attained through a pivotally mounted tray lid 38 in an open condition, as illustrated in the FIG. 3, wherein the tray lid 38 is moveable to a closed condition, hermetically sealing the contents of the input/output tray 36. In the extended and open condition, food items can be placed in the tray. With the tray lid 38 in the closed condition the input/output tray 36 may be slid back to the contracted condition. The compressor 78 may be fluidly connected to the tray compartment so that any contaminated room air within the tray compartment may be purged and replaced with a predetermined food management gas. UV pulses may be briefly applied to the contents of the tray compartment via an upper UV source 14 and/or a plurality of side UV sources 24. The inner surface of the tray compartment may provide nanoparticles to help combat the contamination that was introduced when the input/output tray 36 was outside the sterile first compartment 80.

A dipping tray 32 may be disposed along a lower portion of the first compartment 80. The dipping tray 32 may define a dipping tray compartment accessible when moving a dipping lid 34 pivotally connected to the dipping tray 32 from a sealed condition to an open condition, as illustrated in FIG. 4. The dipping tray compartment may contain a dipping solution (not shown). The dipping in the preservation apparatus contains solution may be adapted to help introduce substances onto and into the food items through contain substances that will contribute to preservation, delaying ripening thereof, while maintaining overall fruit and vegetable quality. The dipping solution may contain items that help to naturally inhibit Ethylene metabolism, and strengthen the cell walls to delay senescence, including but not limited to natural plant substances—such as Polyamines or Gibberellins that directly inhibit Ethylene processes—Calcium Chloride and Vitamin C Ascorbates adapted to maintain the strength and physical integrity of the food items over long periods of time. In certain embodiments, the dipping solution may be a viscous ointment that may be smeared on the outer surface of a food item. In the ripening apparatus the dipping solution contains substances that encourage ripening, strengthen cell walls, and stimulate or promote flavor development within the food item.

The dipping solution may be kept in an auxiliary tank 84 and selectively pumped in and out of the dipping tray compartment via a tray tube 40 fluidly communicating with said auxiliary tank 84 and to a fluid pump 86, a draining container 88 (housing used dipping solution), a drain valve 90 and a drain 92, illustrated in FIG. 9.

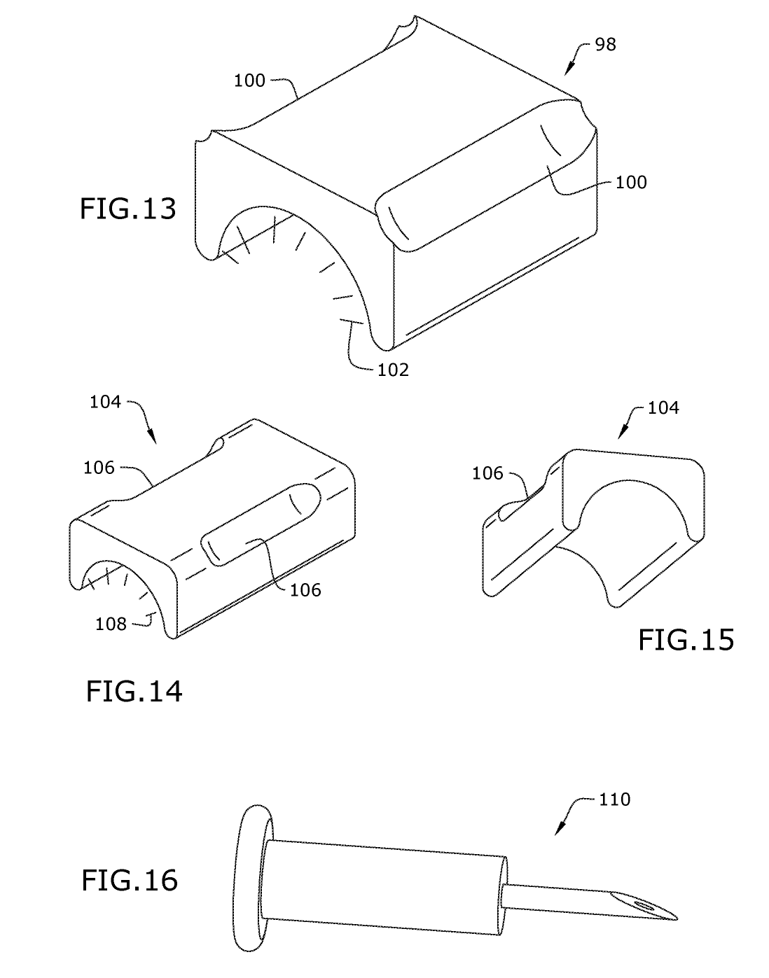

A hand held ultra sound device 98 may be available inside the first compartment 80. The ultra sound device 98 may provide a body 104 having a gripping surface 100, 106 an ultrasonic emitter for emitting ultra sound emissions 102, 108, as illustrated in FIGS. 13-15. The ultra sound device 98 may be adapted to use high frequency ultra sound to penetrate the food item with a probe signal. For example, the ultra sound device 98 may be adapted to emit pulsating ultra sound greater than 1 MHZ, and pulsating UV rays, only when it is continuously rolled over the surface of a fruit or vegetable, only emitting sound while it is moving.

The resulting ultra sound treatment enhances the permeation and diffusing of the solution and UV rays past the outer skin and deeper into the food item. For example, such ultra sound treatments can be done while the food item is in the dipping solution, or after an ointment of the dipping solution has been applied, whereby such ultra sound treatments penetrate up to about one to two cm past the “skin,” “pushing” the dipping substances through opened pathways deeper into the food item then dipping alone. This ultra sound device 98 may be moved over the entire surface of a harvested food item after it is dipped in the solution, or when it is coated with an ointment that contains the dipping solution.

As a result, by way of the active glove(s) 94, the operator may manipulate and dip the contents into the dipping solution. The dipping solution, however, normally affects only the surface and the underside of the skin or cuticle. Then the operator may manipulate the ultra sound device 98 so as to provide such ultra sound treatment. In certain embodiments, a syringe 110 may be provided in the inside the first compartment 80, to facilitate the above mentioned procedures.

The food management apparatus 10, across various embodiments, may provide a fan exhaust 12, a cold air return 114, the upper UV source 14, the plurality of side UV sources 24, 116, the gas intake/exhaust port 16, 118, 52, a plurality of mist sprayers 18, a temperature sensor 28, 124, a humidity sensor 30, a heating element 56, 120, a cooling fan intake 48, 130 a fan outlet 50, a plurality of ice packs 132, an oscillating magnet coil 134, and a pressure sensor 46, 122 operatively disposed in the first compartment 80, 128.

The plurality of mist sprayers 18 are adapted to increase the humidity within the first compartment 80. High humidity helps to replace moisture lost from normal fruit and vegetable respiration, and prevents surface wrinkling. Furthermore, the temperature sensors 28, 124, the humidity sensor 30, the heating element 56, 120, and the pressure sensors 46, 122 are adapted to monitory and maintain a predetermined threshold of humidity, pressure and temperature within the first compartment 80, 128.

The upper UV source 14 and the plurality of side UV sources 24, 116 are adapted for their germicidal, as well as their hormesis (hormetic) effects on the internal biological processes in fruits and vegetables. Periodic low level ultra violet emissions provide a controlled abiotic stress on fruits and vegetables that delays post-harvest ethylene production and influences internal biological protection mechanisms that control senescence. The food items that are placed in the first compartment 80, 128 are periodically exposed to pulsating UV emissions, wherein the highly reflective surfaces therein ensure complete UV saturation over the surface of all food items present.

There are two ways to place the food items onto the plurality of adjustable grated shelves 20. One method is to move the first and second moveable walls 42, 44, or 138 in the open condition, and place the items on the plurality of adjustable grated shelves 20 by hand. This method results in complete contamination of the first compartment 80, 128 with room gas. The second method is to only open the second moveable walls 44 and use the input/output tray 36 and active glove 94 to place the items on the plurality of adjustable grated shelves 20. This second method maintains the sterile integrity of the first compartment 80.

The second compartment 152, 164 may be completely sealed off from the first compartment 80, 128. The second compartment 152, 164 may provide a cooler compartment defined by a plurality of walls and a pivotally moveable access door 160, 172. The plurality of walls may provide a vent 158, 170. The cooler compartment may be lined with “ice packs” 154, 166 containing a refrigerant material. A conduit 156, 168, preferably metal, may passes through the entire length of the second compartment 152, 164 so as to carry the air and thus air temperature to the first compartment 80, 128, via the fan exhaust/output 12/50, wherein the conduit 156, 168 terminates. The conduit 156, 168, may be fluidly connected to a flow of cooled food management gas 174, 162 that gets cooled while it passes through the second compartment 152, 164. A thermal sensor controls the fan, the gas flow, and the temperature.

the second compartment 152, 164 can be cooled using a traditional vapor condensing refrigeration method. The freezing apparatus 136 may or may not contain cooling device 170. If the freezing apparatus does not contain 170, it can be connected to the preserving apparatus cooler 158 by using the attachments 146, 148, and 150 on the back of the preserving apparatus. FIG. 22 is the back view of preserving and freezing apparatuses. an inlet 146, an outlet 148 and an electronic connector 150 for such purposes, as illustrated in FIG. 22. The method of using the present invention may include the following. The food management apparatus 10 disclosed above may be provided. The food management apparatus 10 may be configured in a preserving apparatus, as illustrated in FIGS. 1-5, for maintaining an absolute sterile, germicidal, environment that will completely eliminate surface, and subsurface, microbial activity. A user has the option to either place the ripe or unripe food items directly or indirectly onto the plurality of adjustable grated shelves 20, 126, as mentioned above.

In certain embodiments, the moving of the first and/or the second moveable wall 42, 44 may include confirmation and or acknowledgment by way of a light-indicted “open” button(s) (not shown), wherein a first light may indicate that the UV emissions have stopped, and the second moveable wall 44 has been unlocked and can be safely opened.

Prior to moving the first moveable wall 42, or moveable wall 138, to the open condition, the compressor 78 may be adapted to be activated so that the food management gas may be removed from the first compartment 80, 128 and pumped back into the holding tank 72. Room air is then allowed to flow into the first compartment 80, 128 and the first moveable wall 42, or 138, is then unlocked.

Similarly, prior to the input/output tray 36 being used for indirect placement the user may have to first depress a “I/O” button (not shown) so that if food management gas is present in the associated tray compartment the compressor 78 pumps that food management gas back to the holding tank 72. When ready, the input/output tray 36 is moved to the contracted condition, the user may press the “I/O” button for the second time so that the input/output tray 36 is locked in place, the “outside room air” is purged there from and replaced with the food management gas.

After the food items have been placed within the first compartment 80, 128, regardless of which method was used, the second moveable wall 44,138 may be closed and a “start” button (not shown) pressed. The moveable walls 42, 44,138 may be automatically locked and cannot be opened by the user until the “open” button is pressed. Like above, the compressor 78 purges and replaces the first compartment 80, 128 with food management gas. When the pressure sensor 46, 122 detects that the room air has been removed a valve on the gas holding tank 72 may be opened and the food management gas rushes in to fill the lower pressured first compartment 80, 128. The UV maintenance and preserving treatments are then initiated saturating the first compartment 80, 128 with UV emissions. The mist sprayers 18 periodically emit water vapor to help increase the humidity in the first compartment 80. The fan exhaust/outlet 12/50 starts to circulate the food management gas through the second compartment 152, 164.

When the user is ready to remove items, the above process is relevant in terms of purging and replacing food management gas, and the use of light-indicated buttons to facilitate such process.

### Processing

After the food items are placed in the food management apparatus 10 they are subject to elaborate endogamous and exogamous processing events disclosed above, including the introduction—via the food management gas—of high levels of a nonreactive gas help to prevent the degenerative effects from oxidation. Carbon dioxide is a natural inhibitor of Ethylene. Fruits and vegetables are living substances and require at least a small amount of Oxygen to function normally. Low temperatures inactivate microorganism growth, and slow down fruit and vegetable senescence. High humidity helps to maintain the moisture level of the food item and prevent wrinkling and “drying out” from moisture loss. UV emissions not only quickly destroy many microbes it also elicits a hormesis response in fruits and vegetables causing the food items to produce biological counter measures. These counter measures include enhancing the chlorophyll content and suppressing the Ethylene and ripening mechanisms both of which help to preserve and lengthen the unripe stage.

### Ripening Apparatus

The food management apparatus 10 may be configured into multiple embodiments. For example, a ripening apparatus 70 or a freezing apparatus 112, as illustrated in FIGS. 6 and 7, and FIGS. 17-20, respectively. The ripening apparatus 70 may provide a food management gas having a reactive ripening gas like ethylene, oxygen, and other influential gases. The ripening apparatus 70 may include a dipping solution providing growth and ripening substances as well as other substances that encourage ethylene metabolism and those that fortify the cell walls.

After the ripe food items are removed from the ripening apparatus they can either be consumed or placed in the preserving apparatus to maintain their ripe state for a period of time, or put in the freezing apparatus to suspend all activity for an extended period.

It should be understood, of course, that the foregoing relates to exemplary embodiments of the invention and that modifications may be made without departing from the spirit and scope of the invention as set forth in the following claims.

1. An apparatus, comprising:
a first compartment defined by a plurality of sidewalls and a first moveable wall, wherein the first moveable wall pivots between an open condition and a closed condition, hermetically sealing the first compartment;
a portal opening defined by the first movable wall;
an active glove sealed along the portal opening;
an input/output tray provided by one of the plurality of sidewalls, wherein the input/output tray slides between an extended condition and a contracted condition, hermetically sealing the first compartment; and
a food management gas fluidly connected to the first compartment.

2. The apparatus of claim 1, further comprising a dipping tray disposed along a lower portion of the first compartment, wherein the dipping tray provides a dipping solution.

3. The apparatus of claim 2, further comprising a fluid pump coupled to an auxiliary tank, wherein the auxiliary tank fluidly communicates the dipping solution to the dipping tray.

4. The apparatus of claim 1, wherein the food management gas includes argon, carbon dioxide, and oxygen at ratio of 80 parts per 100, 18 parts per 100, and 2 parts per 100, respectively.

5. The apparatus of claim 1, wherein the food management gas is fluidly connected to the input/output tray.

6. The apparatus of claim 1, wherein the first moveable wall is transparent.

7. An apparatus, comprising:
a first compartment defined by a plurality of sidewalls and a transparent first moveable wall, wherein the first moveable wall pivots between an open condition and a closed condition, hermetically sealing the first compartment;
a portal opening defined by the first movable wall;
an active glove sealed along the portal opening;
an input/output tray provided by one of the plurality of sidewalls, wherein the input/output tray slides between an extended condition and a contracted condition, hermetically sealing the first compartment;
a food management gas fluidly connected to the first compartment and the input/output tray, wherein the food management gas includes argon, carbon dioxide, and oxygen at ratio of 80 parts per 100, 18 parts per 100, and 2 parts per 100, respectively; and
a dipping tray disposed along a lower portion of the first compartment, wherein the dipping tray provides a dipping solution, wherein the dipping solution inhibits at least one ethylene process.

8. The apparatus of claim 3, further comprising a reflective surface provided along at least one of the plurality of sidewalls facing the first compartment for reflecting UV emissions therein.

9. The apparatus of claim 3, further comprising nanoparticles provided along at least one of the plurality of sidewalls facing the first compartment.

10. The apparatus of claim 3, further comprising a compressor fluidly coupled to the first compartment for purging gas therefrom.

11. The apparatus of claim 3, further comprising a hand held ultra sound device disposed within the first compartment so as to be manually used via the active glove.
